(19) United States
(12) Patent Application Publication
(10) Pub. No.: US 2025/0199752 A1
(43) Pub. Date: Jun. 19, 2025

(54) METHOD, APPARATUS, DEVICE AND COMPUTER READABLE STORAGE MEDIUM FOR AUDIO PROCESSING

(71) Applicant: Beijing Zitiao Network Technology Co., Ltd., Haidian District (CN)

(72) Inventors: Weisi Wang, Beijing (CN); Jin Huang, Beijing (CN); Hao Huang, Beijing (CN); Haixing Wang, Beijing (CN)

(21) Appl. No.: 18/922,190

(22) Filed: Oct. 21, 2024

(30) Foreign Application Priority Data
Dec. 16, 2023 (CN) 202311737637.4

(51) Int. Cl. G06F 3/16

(52) U.S. Cl. CPC G06F 3/162

(57) ABSTRACT

The embodiments of the disclosure provide a method, an apparatus, a device and a storage medium for audio processing. The method includes: obtaining trigger information in a target time period, the trigger information indicating a trigger state of an audio input device in the target time period, the target time period being associated with a plurality of audio sampling points; determining a target state of an envelope based on at least the trigger information; determining a first set of audio sampling points corresponding to the target state from the plurality of audio sampling points; and rendering the first set of audio sampling points of the plurality of audio sampling points based on the target state. In this way, embodiments of the disclosure can render a plurality of audio sampling points in batches, thereby improving the efficiency of audio processing.

### CROSS REFERENCE

The application claims priority to Chinese Patent Application No. 202311737637.4, filed on Dec. 16, 2023 and entitled “METHOD, APPARATUS, DEVICE AND COMPUTER READABLE STORAGE MEDIUM FOR AUDIO PROCESSING”, the entirety of which is incorporated herein by reference.

### FIELD

Example embodiments of the disclosure generally relate to the field of computers, and in particular, to a method, an apparatus, a device, and a computer-readable storage medium for audio processing.

### BACKGROUND

With the development of computer technology, digital audio processing is an important task. In digital audio processing, the envelope of sound (also known as envelope lines or envelope maps) is important data used to describe the sound volume change.

For example, the ADSR envelope may include four phases of sound: “Attack”, “Decay”, “Sustain”, and “Release”. During the audio rendering process, the generation and processing efficiency of the envelope will directly affect the real-time performance of the audio output.

### SUMMARY

In a first aspect of the disclosure, a method of audio processing is provided. The method comprises: obtaining trigger information in a target time period, the trigger information indicating a trigger state of an audio input device in the target time period, the target time period being associated with a plurality of audio sampling points; determining a target state of an envelope based on at least the trigger information; determining a first set of audio sampling points corresponding to the target state from the plurality of audio sampling points; and rendering the first set of audio sampling points of the plurality of audio sampling points based on the target state.

In a second aspect of the disclosure, an apparatus for audio processing is provided. The apparatus comprises: an information obtaining module, configured to obtain trigger information in a target time period, the trigger information indicating a trigger state of an audio input device in the target time period, the target time period being associated with a plurality of audio sampling points; a first determining module, configured to determine a target state of an envelope based on at least the trigger information; a second determining module, configured to determine a first set of audio sampling points corresponding to the target state from the plurality of audio sampling points; and an audio rendering module, configured to render the first set of audio sampling points of the plurality of audio sampling points based on the target state.

In a third aspect of the disclosure, an electronic device is provided. The device comprises: at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the disclosure, a computer-readable storage medium is provided. The medium has stored thereon a computer program which, when executed by a processor, implements the method of the first aspect.

It should be understood that the content described in this section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates an audio rendering process according to a conventional solution;

FIG. 2 illustrates a schematic diagram of an example environment in which embodiments of the disclosure can be implemented;

FIG. 3 illustrates a flowchart of an example audio processing process according to some embodiments of the disclosure;

FIG. 4 illustrates a schematic diagram of an example audio processing process according to some embodiments of the disclosure;

FIG. 5 illustrates a schematic structural block diagram of an example information processing apparatus according to some embodiments of the disclosure; and

FIG. 6 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, rather, these embodiments are provided for a more thorough and complete understanding of the disclosure. It should be understood that the drawings and embodiments of the disclosure are for illustrative purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, obtain and/or use of data, and the like. These aspects all follow the corresponding laws and regulations and related rules. In the embodiments of the disclosure, all data is collected, obtained, processed, fabricated, forwarded, used, etc., all of which are performed on the premise that the user knows and confirms. Accordingly, when implementing the embodiments of the disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the disclosure is not limited in this respect.

According to the solutions in the specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects to process personal information other than necessary information required by basic function, and does not affect the basic function of the user.

As briefly mentioned above, the generation and processing efficiency of the envelope will directly affect the real-time performance of the audio output.

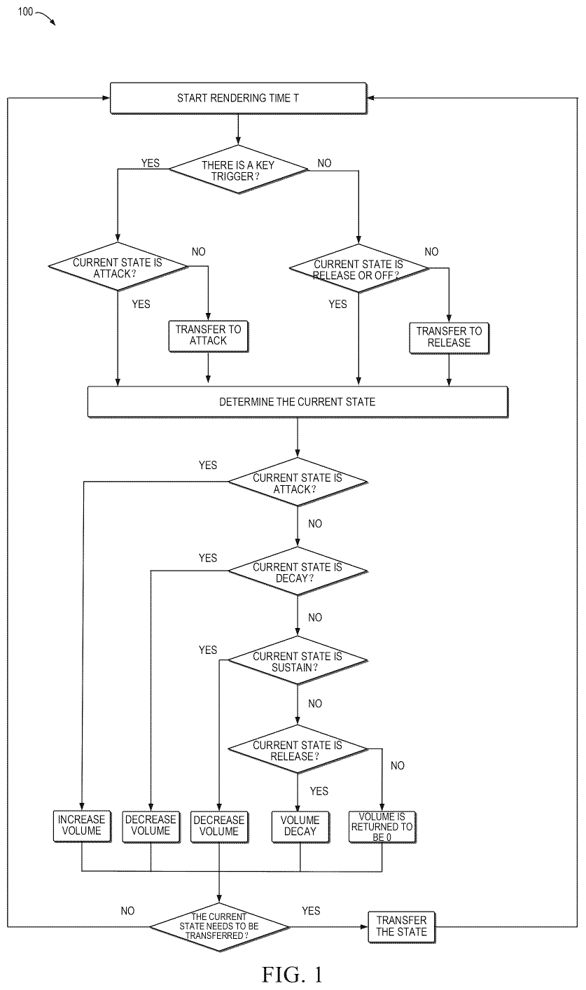

FIG. 1 illustrates a schematic diagram 100 of an audio processing process according to a conventional solution. As shown in FIG. 1, a conventional audio processing process is to perform an audio rendering procedure per audio sampling points.

Specifically, as shown in FIG. 1, for each audio sampling point, the audio processing device first needs to determine whether the current audio sampling point corresponds to a key trigger (for example, whether the piano key is pressed).

Further, the audio processing device needs to determine a current state corresponding to the audio sampling point. For example, if there is a key trigger, the audio processing device needs to determine whether the current state is an attack state (Attack), and if the current state is not an attack state, it needs to be transferred to the attack state.

In contrast, if there is no key trigger, the audio processing device needs to determine whether the current state is a release state or an off state (Off), and if not, the audio processing device needs to transfer the audio to the release state.

Further, the audio processing device needs to calculate the output values of the audio sampling points according to the current state. Specifically, if it is an attack state, the volume is increased; if it is a decay state, the volume is decreased; if it is a sustain state, the volume is held; if it is a release state, the volume is attenuated; and if it is the off state, the volume is returned to be 0.

Further, the audio processing device needs to determine whether a state needs to be transferred, and may end a rendering process of the current sampling point, and perform processing of a next sampling point.

It can be seen that during such processing, the audio processing device needs to perform rendering per audio sampling point. Each audio sampling point needs to call to execute the above process, which has repeated assignment and function jump problems, which directly leads to a great discount of operation efficiency.

The embodiment of the disclosure provides a method of information processing. According to the method, the trigger information in the target time period can be obtained, the trigger information indicates the trigger state of the audio input device in the target time period, and the target time period is associated with the plurality of audio sampling points. Further, the target state of the envelope may be determined based at least on the trigger information.

Correspondingly, the first set of audio sampling points corresponding to the target state may be determined from the plurality of audio sampling points. Further, the first set of audio sampling points in the plurality of audio sampling points may be rendered based on the target state.

In this way, the embodiments of the disclosure can render a plurality of audio sampling points in batches, thereby improving the efficiency of audio processing.

Various example implementations of this method are described in detail below in conjunction with the accompanying drawings.

### Example Environment

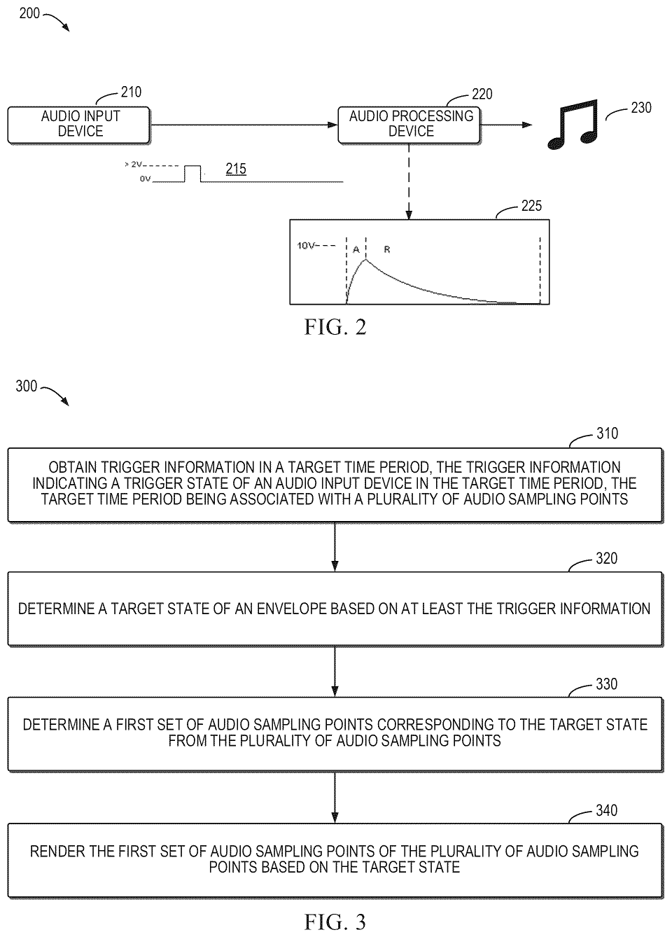

FIG. 2 illustrates a schematic diagram of an example environment 200 in which embodiments of the disclosure can be implemented. As shown in FIG. 2, the example environment 200 may include an audio input device 210 and an audio processing device 220.

As shown in FIG. 2, the audio processing device 220 may obtain trigger information 215, which may indicate a trigger state of the audio input device 210. For example, taking the audio input device 210 as a piano as an example, the trigger information 215 may indicate a pressed state of the piano key. In some embodiments, the audio input device 210 may include, for example, a physical input device or a virtual input device.

Further, as will be described in detail below, the audio processing device 220 may render the corresponding audio signal 230 based on the trigger information 215. Specifically, the audio processing device 220 may generate a corresponding envelope 225 based on the trigger information 215, and may perform rendering of the audio signal 230 based on the envelope 225.

The detailed process of the audio processing will be described in detail below.

### Example Processes

FIG. 3 illustrates a flowchart of an example audio processing process 300 according to some embodiments of the disclosure. Process 300 may be implemented at audio processing device 220. The process 300 is described below with reference to FIG. 2.

As shown in FIG. 3, at block 310, the audio processing device 220 obtains the trigger information 215 in the target time period. As introduced above, the trigger information 215 may indicate a triggering state of the audio input device 210 in a target time period, the target time period being associated with a plurality of audio sampling points.

In some embodiments, the audio processing device 220 may process a plurality of audio sampling points in batches. As an example, the audio processing device 220 may take a time period corresponding to a predetermined number (e.g., 256) of audio sampling points as a target time period, and use the target time period as a unit for audio processing.

In some embodiments, the length of the target time period of batch processing may be, for example, less than the length of time of a single note.

At block 320, the audio processing device 220 determines a target state of the envelope based at least on the trigger information 215.

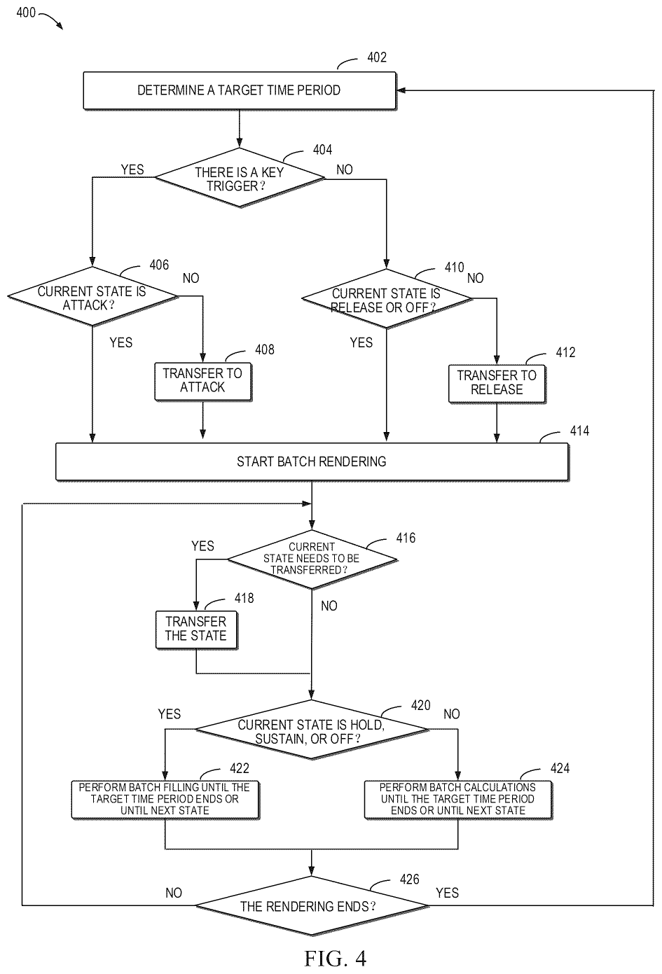

The process 300 will be further described below with reference to FIG. 4, which illustrates a schematic diagram of an audio processing process 400 according to some embodiments of the disclosure.

As shown in FIG. 4, at block 402, the audio processing device 220 may determine a target time period, and determine a plurality of audio sampling points corresponding to the target time period.

Further, the audio processing device 220 may determine the state of the envelope based on the trigger information 215.

In some embodiments, if the trigger information 215 indicates that the audio input device 220 is triggered in the target time period, the target state of the envelope is determined as the attack state.

Specifically, as shown in FIG. 4, the audio processing device 220 may determine, at block 406, whether the current state of the envelope is an attack state (Attack). If not, the audio processing device 220 may transfer the current state to the attack state and use it as the target state at block 408.

In some embodiments, as shown in FIG. 4, if the trigger information 215 indicates that the audio input device 210 is not triggered in the target time period, the audio processing device 220 may determine, at block 410, whether the current state of the envelope is a release state (Release) or an off state (Off).

If the current state is the release state or the off state, the audio processing device 220 may determine the target state of the envelope as the current state, that is, the release state or the off state.

Conversely, if the current state is not a release state or an off state, the audio processing device 220 may transfer the current state to the release state at block 412, and determine the target state of the envelope as the release state.

With continued reference to FIG. 3, at block 330, the audio processing device 220 determines a first set of audio sampling points corresponding to the target state from the plurality of audio sampling points.

Specifically, as shown in FIG. 4, the audio processing device 220 may start batch rendering at block 414. Specifically, the audio processing device 220 may determine, based on the identifiers of the plurality of audio sampling points and the at least one target identifier, a first set of audio sampling points corresponding to the target state from the plurality of audio sampling points, where the at least one target identifier corresponds to at least one audio sampling point indicated by the envelope and whose state changes.

In some embodiments, the audio processing device 220 may set its corresponding identifier for each audio sampling point. As an example, such an identifier may be, for example, a counter number of a corresponding audio sampling point.

Further, the audio processing device 220 may determine, based on the envelope, at least one target identifier corresponding to the audio sampling point whose state has been transferred, for example, a specific counter number.

Further, the audio processing device 220 may corresponding determine, from the plurality of audio sampling points, a first set of sampling points whose state has not been transferred, and may continue to render the first set of sampling points by using the target state determined above.

With continued reference to FIG. 3, at block 340, the audio processing device 220 renders a first set of audio sampling points of the plurality of audio sampling points based on the target state.

Specifically, as shown in FIG. 4, at block 416, the audio processing device 220 may determine whether the state needs to be transferred based on the identifier comparison of the audio sampling points. If no transfer is needed, the audio processing device 220 may process the same first set of audio sampling points in batch.

Further, the audio processing device 220 may determine that the target state indicates that the output values of the first set of audio sampling points do not change. For example, the audio processing device 220 may determine, at block 420, whether the current state corresponds to several states in which the output values do not change, e.g., hold state (Hold), sustain state (Sustain), or Off state (Off).

If so, the audio processing device 220 renders the first set of audio sampling points with a predetermined target output value. For example, as shown in FIG. 4, the audio processing device 220 may perform batch filling with a predetermined target output value (e.g., volume size value) at block 422 until the target time period ends, or until the audio sample point whose the state needs to transfer.

Conversely, if the target state indicates that the output values of the first set of audio sampling points change, the audio processing device 220 may determine the output values of the first set of audio sampling points based on the envelope and may render the first set of audio sampling points based on the calculated output values.

For example, as shown in FIG. 4, if it is determined at block 420 that the current state is not a hold state (Hold), a sustain state (Sustain), or an off state (Off), the audio processing device 220 may perform batch calculations at block 424 until the target time period ends, or until the audio sample point whose the state needs to transfer.

In some embodiments, the audio processing device 220 may perform the batch calculation process shown in block 424, for example, based on single instruction multiple data (SIMD).

Specifically, the audio processing device 220 may determine a first output value of a first audio sampling point in the first set of audio sampling points. Further, based on a transformation relationship between a plurality of second output values of a plurality of second audio sampling points in the first set of audio sampling points and the first output value, the audio processing device 220 may determine the plurality of second output values of the plurality of second audio sampling points in parallel, where the transformation relationship is determined based on the envelope.

Specifically, the audio processing device 220 may determine the second output value of the second audio sampling point based on the following formula and based on the first output value of the first audio sampling point:

$${x}_{n + 1} = ratio * {x}_{n} + ( 1 - ratio ) * overshoot + increment \qquad ( 1 )$$

where, xₙ₊₁ represents an output value of an audio sampling point numbered n+1, ratio represents a coefficient determined based on an envelope, and overshoot and increment represent parameters determined based on an envelope.

Further, the formula (1) may be expressed as:

$${x}_{n + 1} = ratio * {x}_{n} + c \qquad ( 2 )$$

$$c = ( 1 - ratio ) * overshoot + increment$$

Based on formula (2), the audio processing device 220 may construct a change relationship between the second output values of the plurality of second audio sampling points and the first output value of the first audio sampling point:

$${x}_{n + 1} = ratio * {x}_{n} + c \qquad ( 3 )$$

$${x}_{n + 1} = {ratio}^{2} * {x}_{n} + c * ( 1 + ratio ) \qquad ( 4 )$$

$${x}_{n + 3} = {ratio}^{3} * {x}_{n} + c * ( 1 + ratio + {ratio}^{2} ) \qquad ( 5 )$$

$${x}_{n + 4} = {ratio}^{4} * {x}_{n} + c * ( 1 + ratio + {ratio}^{2} + {ratio}^{3} ) \qquad ( 6 )$$

Therefore, the embodiments of the disclosure may no longer depend on the output value of the previous one audio sampling point when determining the output value of the audio sampling point, thereby providing a basis for batch processing.

Specifically, based on formulas (3) to (6), the audio processing device 220 may determine a uniform computing instruction indicated by the transformation relationship, that is, multiply the first output value by a specific value and add a specific value.

Thus, the audio processing device 220 may perform batch computation of a plurality of second audio sampling points based on single instruction multiple data (SIMD). Specifically, the audio processing device 220 may determine a plurality of second output values of the plurality of second audio sampling points in parallel based on the unified computing instruction and using different data corresponding to the plurality of second audio sampling points.

For example, the audio processing device 220 may determine the output values of the four second audio sampling points (e.g., corresponding to the numbers n+1 to n+4) based on the output values of the first audio sampling point (e.g., corresponding to the number n).

In this way, the embodiments of the disclosure can improve audio processing efficiency by batch processing.

With continued reference to FIG. 4, at block 426, the audio processing device 220 may determine whether the rendering of the target time period ends. If so, the audio processing device 220 may process the rendering process for the next time period.

Conversely, if rendering has not ended, the audio processing device 220 may proceed back to block 416 to determine whether the current state needs to be transferred. Further, in a case that it is determined that the current state needs to be transferred, the audio processing device 220 may determine, at block 418, an update state of the envelope in the target time period.

Further, the audio processing device 220 may determine a second set of audio sampling points corresponding to the update state from the plurality of audio sampling points. Further, the audio processing device 220 may render a second set of audio sampling points of the plurality of audio sampling points based on the update state.

Specifically, the audio processing device 220 may utilize the update state to perform the rendering of the second set of audio sampling points in the target time period based on the processes of blocks 420,422, and 424 introduced above, and details are not described herein again.

Based on the process described above, the embodiments of the disclosure can render a plurality of audio sampling points in batches, thereby improving the efficiency of audio processing.

### Example Apparatus and Device

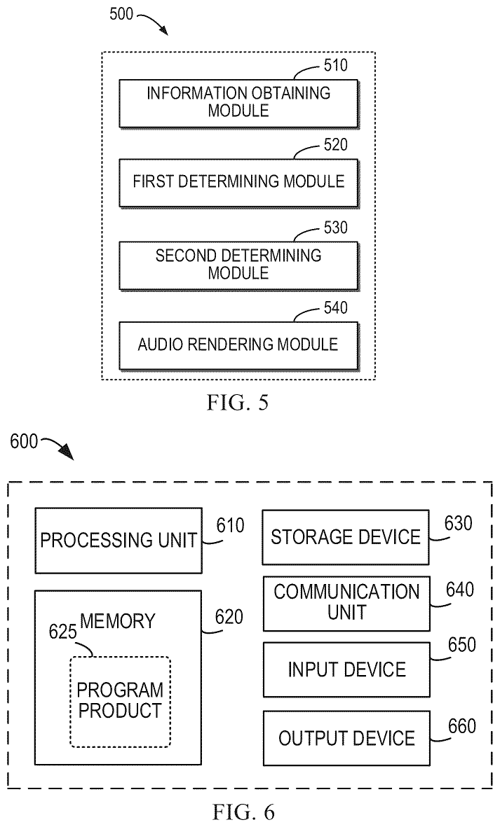

Embodiments of the disclosure also provide a corresponding apparatus for implementing the above method or process. FIG. 5 illustrates a schematic structural block diagram of an example information processing apparatus 500 according to some embodiments of the disclosure. The apparatus 500 may be implemented or included in the audio processing device 220. The various modules/components in the apparatus 500 may be implemented by hardware, software, firmware, or any combination thereof.

As shown in FIG. 5, the apparatus 500 includes: an information obtaining module 510, configured to obtain trigger information in a target time period, the trigger information indicating a trigger state of an audio input device in the target time period, the target time period being associated with a plurality of audio sampling points; a first determining module 520, configured to determine a target state of an envelope based on at least the trigger information; a second determining module 530, configured to determine a first set of audio sampling points corresponding to the target state from the plurality of audio sampling points; and an audio rendering module 540, configured to render the first set of audio sampling points of the plurality of audio sampling points based on the target state.

In some embodiments, the first determining module 520 is further configured to: in response to the trigger information indicating that the audio input device is triggered in the target time period, determine the target state of the envelope as an attack state.

In some embodiments, the first determining module 520 is further configured to: in response to the trigger information indicating that the audio input device is not triggered in the target time period, determine whether a current state of the envelope is a release state or an off state; in response to the current state being the release state or the off state, determine the target state of the envelope as the current state; and in response to the current state not being the release state or the off state, determine the target state of the envelope as the release state.

In some embodiments, the second determining module 530 is further configured to: determine, based on identifiers of the plurality of audio sampling points and at least one target identifier, the first set of audio sampling points corresponding to the target state from the plurality of audio sampling points, wherein the at least one target identifier corresponds to at least one audio sampling point that is indicated by the envelope and whose state changes.

In some embodiments, the identifiers of the plurality of audio sampling points comprise a counter number of a respective audio sampling point.

In some embodiments, the audio rendering module 540 is further configured to, in response to the target state indicating that output values of the first set of audio sampling points do not change, render the first set of audio sampling points by using a predetermined target output value.

In some embodiments, the audio rendering module 540 is further configured to: in response to the target state indicating that output values of the first set of audio sampling points change, determine output values of the first set of audio sampling points based on the envelope; and render the first set of audio sampling points based on the calculated output values.

In some embodiments, the audio rendering module 540 is further configured to: determine a first output value of a first audio sampling point in the first set of audio sampling points; based on a transformation relationship between a plurality of second output values of a plurality of second audio sampling points in the first set of audio sampling points and the first output value, determine the plurality of second output values of the plurality of second audio sampling points in parallel, wherein the transformation relationship is determined based on the envelope.

In some embodiments, the transformation relationship corresponds to a unified computing instruction, and the audio rendering module 540 is further configured to: determine the plurality of second output values of the plurality of second audio sampling points in parallel based on the unified computing instruction by using different data corresponding to the plurality of second audio sampling points.

In some embodiments, the audio rendering module 540 is further configured to: determine an update state of the envelope in the target time period; determine a second set of audio sampling points corresponding to the update state from the plurality of audio sampling points; and render the second set of audio sampling points of the plurality of audio sampling points based on the update state.

In some embodiments, the target time period is associated with the plurality of sampling points with a predetermined number.

The modules and/or units included in the apparatus 500 may be implemented in various ways, including software, hardware, firmware, or any combination thereof. In some embodiments, one or more modules and/or units may be implemented using software and/or firmware, such as machine-executable instructions stored on a storage medium. In addition to or as an alternative to machine-executable instructions, some or all of the modules and/or units in the apparatus 500 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 in which one or more embodiments of the disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be configured to implement the audio processing device 220 in FIG. 2.

As shown in FIG. 6, the electronic device 600 is in the form of a general-purpose computing device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data (e.g., training data for training) and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example embodiments of the disclosure, there is provided a computer-readable storage medium having computer-executable instructions stored thereon, wherein the computer-executable instructions are executed by a processor to implement the method described above. According to an example embodiment of the disclosure, a computer program product is further provided, the computer program product being tangibly stored on a non-transient computer readable medium and comprising computer executable instructions, the computer executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various embodiments disclosed herein.

I/We claim:

1. A method of audio processing, comprising:
obtaining trigger information in a target time period, the trigger information indicating a trigger state of an audio input device in the target time period, the target time period being associated with a plurality of audio sampling points;
determining a target state of an envelope based on at least the trigger information;
determining a first set of audio sampling points corresponding to the target state from the plurality of audio sampling points; and
rendering the first set of audio sampling points of the plurality of audio sampling points based on the target state.

2. The method of claim 1, wherein determining the target state of the envelope based at least on the trigger information comprises:
in response to the trigger information indicating that the audio input device is triggered in the target time period, determining the target state of the envelope as an attack state.

3. The method of claim 1, wherein determining the target state of the envelope based at least on the trigger information comprises:
in response to the trigger information indicating that the audio input device is not triggered in the target time period, determining whether a current state of the envelope is a release state or an off state;
in response to the current state being the release state or the off state, determining the target state of the envelope as the current state; and
in response to the current state not being the release state or the off state, determining the target state of the envelope as the release state.

4. The method of claim 1, wherein determining the first set of audio sampling points corresponding to the target state from the plurality of audio sampling points comprises:
determining, based on identifiers of the plurality of audio sampling points and at least one target identifier, the first set of audio sampling points corresponding to the target state from the plurality of audio sampling points, wherein the at least one target identifier corresponds to at least one audio sampling point that is indicated by the envelope and whose state changes.

5. The method of claim 4, wherein the identifiers of the plurality of audio sampling points comprise a counter number of a respective audio sampling point.

6. The method of claim 1, wherein rendering the first set of audio sampling points of the plurality of audio sampling points based on the target state comprises:
in response to the target state indicating that output values of the first set of audio sampling points do not change, rendering the first set of audio sampling points by using a predetermined target output value.

7. The method of claim 1, wherein rendering the first set of audio sampling points of the plurality of audio sampling points based on the target state comprises:
in response to the target state indicating that output values of the first set of audio sampling points change, determining output values of the first set of audio sampling points based on the envelope; and
rendering the first set of audio sampling points based on the calculated output values.

8. The method of claim 7, wherein determining output values of the first set of audio sampling points based on the envelope comprises:
determining a first output value of a first audio sampling point in the first set of audio sampling points;
based on a transformation relationship between a plurality of second output values of a plurality of second audio sampling points in the first set of audio sampling points and the first output value, determining the plurality of second output values of the plurality of second audio sampling points in parallel, wherein the transformation relationship is determined based on the envelope.

9. The method of claim 8, wherein the transformation relationship corresponds to a unified computing instruction, and determining the plurality of second output values of the plurality of second audio sampling points in parallel comprises:
determining the plurality of second output values of the plurality of second audio sampling points in parallel based on the unified computing instruction by using different data corresponding to the plurality of second audio sampling points.

10. The method of claim 1, further comprising:
determining an update state of the envelope in the target time period;
determining a second set of audio sampling points corresponding to the update state from the plurality of audio sampling points; and
rendering the second set of audio sampling points of the plurality of audio sampling points based on the update state.

11. The method of claim 1, wherein the target time period is associated with the plurality of sampling points with a predetermined number.

12. An electronic device comprising:
at least one processing unit; and
at least one memory coupled to the at least one processing unit and storing instructions for execution by the at least one processing unit, the instructions, when executed by the at least one processing unit, causing the electronic device to perform acts comprising:
obtaining trigger information in a target time period, the trigger information indicating a trigger state of an audio input device in the target time period, the target time period being associated with a plurality of audio sampling points;
determining a target state of an envelope based on at least the trigger information;
determining a first set of audio sampling points corresponding to the target state from the plurality of audio sampling points; and
rendering the first set of audio sampling points of the plurality of audio sampling points based on the target state.

13. The electronic device of claim 12, wherein determining the target state of the envelope based at least on the trigger information comprises:
in response to the trigger information indicating that the audio input device is triggered in the target time period, determining the target state of the envelope as an attack state.

14. The electronic device of claim 12, wherein determining the target state of the envelope based at least on the trigger information comprises:
in response to the trigger information indicating that the audio input device is not triggered in the target time period, determining whether a current state of the envelope is a release state or an off state;
in response to the current state being the release state or the off state, determining the target state of the envelope as the current state; and
in response to the current state not being the release state or the off state, determining the target state of the envelope as the release state.

15. The electronic device of claim 12, wherein determining the first set of audio sampling points corresponding to the target state from the plurality of audio sampling points comprises:
determining, based on identifiers of the plurality of audio sampling points and at least one target identifier, the first set of audio sampling points corresponding to the target state from the plurality of audio sampling points, wherein the at least one target identifier corresponds to at least one audio sampling point that is indicated by the envelope and whose state changes.

16. The electronic device of claim 15, wherein the identifiers of the plurality of audio sampling points comprise a counter number of a respective audio sampling point.

17. The electronic device of claim 12, wherein rendering the first set of audio sampling points of the plurality of audio sampling points based on the target state comprises:
in response to the target state indicating that output values of the first set of audio sampling points do not change, rendering the first set of audio sampling points by using a predetermined target output value.

18. The electronic device of claim 12, wherein rendering the first set of audio sampling points of the plurality of audio sampling points based on the target state comprises:
in response to the target state indicating that output values of the first set of audio sampling points change, determining output values of the first set of audio sampling points based on the envelope; and
rendering the first set of audio sampling points based on the calculated output values.

19. The electronic device of claim 18, wherein determining output values of the first set of audio sampling points based on the envelope comprises:
determining a first output value of a first audio sampling point in the first set of audio sampling points;
based on a transformation relationship between a plurality of second output values of a plurality of second audio sampling points in the first set of audio sampling points and the first output value, determining the plurality of second output values of the plurality of second audio sampling points in parallel, wherein the transformation relationship is determined based on the envelope.

20. A non-transitory computer readable storage medium having stored thereon a computer program which, when executed by a processor, implements acts comprising:
obtaining trigger information in a target time period, the trigger information indicating a trigger state of an audio input device in the target time period, the target time period being associated with a plurality of audio sampling points;
determining a target state of an envelope based on at least the trigger information;
determining a first set of audio sampling points corresponding to the target state from the plurality of audio sampling points; and
rendering the first set of audio sampling points of the plurality of audio sampling points based on the target state.
